(19) United States
(12) Patent Application Publication
(10) Pub. No.: US 2026/0270501 A1
(43) Pub. Date: Sep. 10, 2026

(54) Method for managing time-shifted access to chunks of content having been broadcast in real time

(71) Applicant: Orange, Issy-les-Moulineaux (FR)

(72) Inventors: Olivier GASTE, CHATILLON CEDEX (FR); Hervé MARCHAND, CHATILLON CEDEX (FR)

(21) Appl. No.: 19/556,422

(22) Filed: Mar. 4, 2026

(30) Foreign Application Priority Data
Mar. 10, 2025 (FR) FR2502346

(51) Int. Cl. H04N 21/433; H04N 21/462

(52) U.S. Cl. CPC H04N 21/4331; H04N 21/462

(57) ABSTRACT

A method for managing the storage of chunks of multimedia content. The multimedia content is broadcast from a broadcast server via a communication network. A playback device includes a memory for storing chunks before the chunks are played back. The chunks are retained in the memory after playback.

### CROSS-REFERENCE TO RELATED APPLICATIONS

This application claims priority to French Patent Application No. FR2502346, filed Mar. 10, 2025, the entire content of which is incorporated herein by reference.

### TECHNICAL FIELD

The field of the present disclosure is that of managing the storage of content currently being broadcast with a view to time-shifted playback by a playback device.

The playback device is any data-processing device equipped with a processor and capable of receiving and playing back or replaying content broadcast from a content server.

A playback device of this type is for example a set-top box.

The content in question here is multimedia content. This content is for example televised content.

### PRIOR ART

When multimedia content is accessed, a playback device sends a request to a content server indicating chosen multimedia (video and/or audio) content. The playback device receives, in return, a digital data stream relating to this content.

The received data are then decoded by the playback device, before being rendered in the form of a display of the corresponding multimedia content.

The content server is able to transmit content in several ways, namely in multicast mode (for example IPTV), in unicast mode, etc. After receiving the content, the playback device decodes the content and requests rendering on a rendering device.

“Live” video content broadcasting using HTTP Adaptive Streaming (HAS) allows video to be broadcast in OTT mode, the user being offered the best possible quality given the bandwidth available on the network. This type of streaming is based on an exchange of a manifest file (also called a “manifest” by those skilled in the art) between a HAS content broadcast server and a client playback device. This manifest file describes (in the form of URLs), for live streams, the latest video chunks that have been produced. These chunks generally all have the same duration (for example 2 seconds).

In addition to playback of content, some playback devices offer what those skilled in the art call a “start-over” function that allows a user, for example when they are watching content broadcast in real time (a live channel), to replay in time-shifted mode some of the content that has been broadcast live; this function in particular allows content to be replayed from a desired time, from its start for example. For example, if a movie broadcast in real time starts at 9.00 pm and the user accesses the corresponding live stream by switching to the channel at 9.40 pm, the user may ask, by selecting a command associated with the start-over function, for playback of the content to restart for example from a desired time, 9.15 pm for example, or even from the start of the movie, namely 9.00 pm. In this case, a change takes place from a real-time playback mode to a time-shifted playback mode.

In order to allow a user to return to programs that have been broadcast for several hours, the manifest files that are successively transmitted from the server describe not only the latest audio/video chunks produced corresponding to what is live, but also all the chunks that have been recorded for several hours (four hours for example) and are accessible in start-over mode. A very significant increase in the size of the manifest file is then observed, which changes from a size of the order of 12 kB (description of 30 chunks of 2 seconds) for “live” to a size of the order of 2.8 MB (description of 7200 chunks of 2 seconds) for 4 hours of description of chunks. This increase in the size of the manifest file necessitates a consumption of bandwidth that becomes non-negligible, especially for ADSL users, and also a longer transmission duration due to its larger size and large parsing times that may penalize the fluidity of the graphical interface.

### SUMMARY

One or more aspects of the present disclosure improve the situation.

To this end, according to one functional aspect, the disclosure relates to a method for managing the storage of chunks of multimedia content, the multimedia content being broadcast from a broadcast server via a communication network, the playback device comprising a memory for storing chunks before the chunks are played back, wherein the chunks are retained in the memory after playback.

Unlike the prior art, in which the stored chunks are only real-time chunks corresponding to what is live, an aspect of the present disclosure also proposes to store, in the memory of the playback device, chunks that have been played back in order to allow time-shifted local access to chunks.

In other words, a memory space (buffer) is dedicated, in the memory of the playback device, to the audio/video chunks that are to be played back, like in the prior art; and also an audio/video memory space (buffer), again in the playback device or more generally associated locally with the playback device, for chunks that have been played back by the playback device. The latter memory space corresponds to a “retention buffer” capable of retaining played-back chunks in memory instead of deleting them after playback like in the prior art. It will be seen that the size (or depth) of this retention buffer (and therefore of chunks that have already been played back) may be either of fixed size (for example 30 seconds, thereby making it possible to jump back 3 times in the past by 10 seconds) or of dynamic size, depending on the memory available on the equipment.

The retention duration is relatively short due to the size of the memory, which is often limited. An aspect of the present disclosure is therefore useful when the time-shifted playback concerns relatively recent chunks of content.

Ultimately, the time-shifted playback of chunks takes place locally, unlike the prior art, which, following a request for time-shifted playback, requires downloading manifest files describing the chunks in question and downloading the chunks in question from the communication network.

According to one embodiment, the chunks are retained in memory over a given duration. This embodiment makes it possible to limit the amount of data stored in the memory space dedicated to the chunks stored after playback by the playback device.

According to another embodiment that may be implemented as an alternative or in addition to the previous embodiments, the chunks that are broadcast are stored in a memory associated with the server, and time-shifted playback comprises playing back retained chunks or playback from the memory associated with the server. This embodiment makes it possible to play back the content in time-shifted mode, regardless of the chunks in question, from a local memory of the playback device or from a remote memory associated with the broadcast server. If the storage of the played-back chunks in the memory is limited to a given duration preceding the current broadcast time, this embodiment makes it possible to play back chunks from the server when the chunks in question are no longer stored in the memory space in question of the playback device.

According to one variant of the latter embodiment, the origin of the chunks to be played back in time-shifted mode depends on the desired time-shifted playback time. According to this embodiment, the chunks may be played back from the server or locally in the playback device, the selected playback time being taken into account to make this choice. For example, considering that the chunks that have been played back are stored in memory over a given duration preceding the current playback time, if the desired playback time is within this time range, the memory of the playback device is used; if the desired playback time is not within this time range, the memory of the server is used. The previous embodiment is not limited to this variant; even if the time-shifted playback time targets chunks stored in the memory storing played-back chunks, there is nothing to prevent chunks stored in the memory associated with the server from being played back.

It is known that accessing chunks requires the playback device to receive successive manifest files beforehand. According to another embodiment that may be implemented as an alternative or in addition to the previous embodiments, the manifest files stop being received while the chunks retained in memory are being played back. This embodiment avoids receiving manifest files needlessly; this makes it possible to save bandwidth.

According to one variant of the previous embodiment, the method comprises resuming reception of the manifest files after the retained chunks have been played back. This variant makes it possible to ensure that the reception of the manifest files resumes and therefore that the content continues to be played back continuously when the chunks to be played back are no longer in the cache memory storing the played-back chunks.

According to another embodiment that may be implemented as an alternative or in addition to the previous embodiments, the chunks are retained in a cache memory. This embodiment allows chunks to be played back more quickly, since said chunks are decoded and ready to be played back.

According to a first hardware aspect, the disclosure relates to a management entity for managing the storage of chunks of multimedia content, the multimedia content being broadcast from a broadcast server via a communication network, the playback device comprising a memory for storing chunks before the chunks are played back, wherein it comprises a retention module capable of retaining chunks in the memory after playback.

According to another hardware aspect, the disclosure relates to a playback device comprising a management entity as defined above.

According to another hardware aspect, the disclosure pertains to a computer program able to be implemented on a management entity as defined above, the program comprising code instructions that, when said program is executed by a processor, carry out the steps of the management method that are defined above.

According to another hardware aspect, the disclosure pertains to a data medium on which at least one series of program code instructions for performing a management method as defined above has been stored.

The abovementioned medium may be any entity or device capable of storing the program. For example, a medium may comprise a storage means, such as a ROM, for example a CD-ROM or a microelectronic circuit ROM, or a magnetic storage means, for example a hard disk. Moreover, an information medium may be a transmissible medium such as an electrical or optical signal, which may be routed via an electrical or optical cable, by radio or by other means. The program according to an aspect of the present disclosure may in particular be downloaded over the Internet. As an alternative, the information medium may be an integrated circuit in which the program is incorporated, the circuit being designed to execute or to be used in the execution of the method in question.

### BRIEF DESCRIPTION OF THE DRAWINGS

One or more aspects of the present disclosure will be better understood on reading the following description, which is given by way of example and with reference to the appended drawings, in which:

FIG. 1 shows a computer system in which an aspect of the present disclosure may be implemented;

FIG. 2 schematically illustrates the hardware structure of a server able to transmit manifest files;

FIG. 3 schematically illustrates the hardware structure of a playback device able to play back multimedia streams in real time;

FIG. 4 illustrates one embodiment of the method of the disclosure. This FIG. 4 illustrates two storage states of memory spaces, namely a space that stores the received chunks and plays them back when there is a sufficient number thereof, and a memory space that retains the played-back chunks instead of erasing them.

### DETAILED DESCRIPTION OF EXEMPLARY EMBODIMENTS OF THE DISCLOSURE

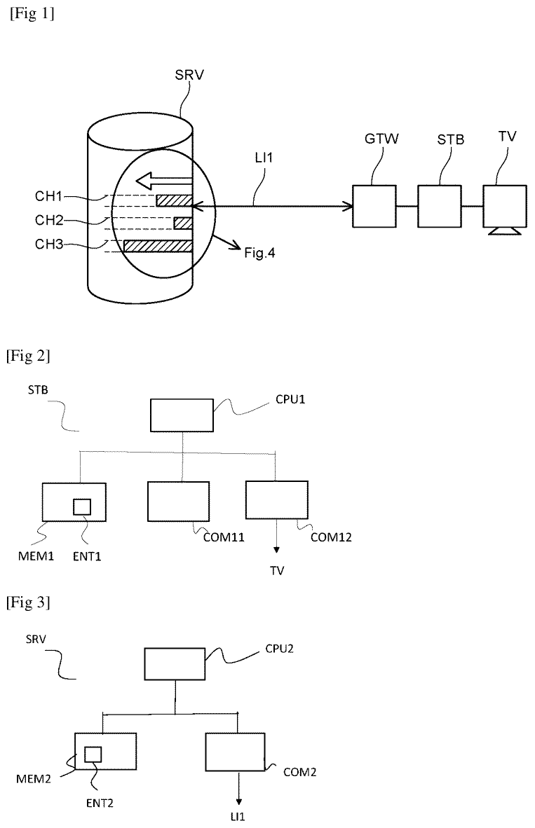

FIG. 1 shows a computer system SYS in which a content distribution network, which is called a CDN by those skilled in the art, is implemented, from which content is transmitted to client devices, here content playback devices, along with manifest files associated with the multimedia content. The content broadcast server, called the content server in the present text, broadcasts on multiple broadcast channels associated with television channels.

In our example, for the sake of simplification of the disclosure, the system SYS comprises a single playback device STB. However, an aspect of the present disclosure is applicable to any number of playback devices, the principle of the invention being able to be implemented on all or some of the playback devices STB.

The playback device STB is for example a digital playback device such as a set-top box.

The multimedia content in question here is video content of a television channel. This content is broadcast from a server that broadcasts what are referred to as live televised programs, that is to say those broadcast in real time.

In our example, the playback device STB is connected to a rendering terminal TV such as a television. The device is able to transmit data to be rendered to the rendering device TV.

In our example, the playback device STB is connected to a port of the rendering device TV; the playback device STB and the rendering device TV could also form one and the same device.

In our example, the playback device STB is located in a local area network LAN managed by a home gateway GTW.

The gateway GTW is able to communicate via a communication link LI1, which may be a telecommunications network such as a wide area network WAN known to those skilled in the art.

In our example, the computer system SYS employs a content distribution network (CDN), as it is known to those skilled in the art, from which content is transmitted to content playback devices STB.

The CDN consists of servers networked in the wide area network; these servers interact in order to make multimedia content available to users. In order to simplify the present disclosure, a single content server SRV will be shown in FIG. 1 to represent the CDN. The content server SRV is located, in our example, in the wide area network WAN.

The content server SRV receives, for example, channels of digital-television content originating from a television broadcast network (not shown) and makes them available to client terminals, here the playback device STB, in real time via broadcast channels.

FIG. 2 shows an architecture of a playback device STB. This device STB comprises, as is conventional, memories MEM1 associated with a processor CPU1. The memories may be read-only memories (ROMs) or random access memories (RAMs) or a cache memory integrated into the processor CPU1. The term “comprise” refers both to the fact that the memories are included in the playback device STB but also the case where the memories are outside the playback device STB but connected via a local link to all or some of these memories MEM1; a locally connected memory is for example a hard disk connected via a USB port.

The playback device STB is able to transmit content to be rendered to the rendering device TV via a communication module COM12. This module COM12 is for example an HDMI link.

The playback device STB communicates with the gateway via an Ethernet module in the case of wired local communication, or via a Wi-Fi radio module in the case of wireless local communication with the home gateway GTW. The module in question is referenced CMO11 in FIG. 2.

In our example, the playback device STB comprises (not shown) a HAS (HTTP Adaptive Streaming) download module capable of managing downloading of chunks of the content when the content is transmitted over the network LI1 in the form of chunks in accordance with the so-called adaptive streaming technique, which is known to those skilled in the art.

It will be recalled briefly here that, when a user accesses a live stream broadcast via HTTP Adaptive Streaming (HAS), the playback device STB successively receives, at regular intervals, in general every two seconds, manifest files (called real-time manifest files below) that generally each describe the latest sixty seconds of the stream (30 chunks of 2 seconds) while providing URL addresses of chunks corresponding to these latest sixty seconds. By virtue of the received chunk addresses, the playback device STB is able to download the chunks and play them back one after another.

With reference to FIG. 3, the server SRV is also equipped with at least one processor CPU2 for carrying out information processing, and with memories MEM2 for storing the produced and downloadable chunks.

The server SRV communicates with the gateway GTW via a WAN. The server comprises a communication module, referenced COM2, for communicating with the WAN.

Sometimes the start of a television program (movie, series, etc.) broadcast in real time is missed, or it is desired to replay content from a given time. A function called “start over” or “restart” by those skilled in the art makes it possible, at any time, to restart the program currently being broadcast at a time prior to the current time; for example, playback of the content may be restarted from its start, or from a time chosen by a user. For example, if a movie starts at 9.00 pm and the user switches to the channel at 9.40 pm, they may request for playback of the content to restart from the start of the movie. In this case, a change takes place from a real-time content playback mode to a time-shifted playback mode.

In order to allow time-shifted access to content, an entity ENT2 present on the server SRV stores the content parts that have been broadcast. In our example, the parts are chunks of content. The chunks that have been broadcast are recorded in memory MEM2 just after they are respectively broadcast; the recorded chunks are then accessible for time-shifted playback.

In our example, in order not to indefinitely store all the chunks that are broadcast, the content parts are stored in the memory MEM2 of the server SRV for a certain duration. Manifest files are created accordingly and include not only
the addresses of the latest chunks produced in order to access the latest chunks produced,
but also the addresses of the stored chunks.

The resulting manifest files are then made available to the playback device STB in order to be able to access the chunks by downloading them using the URL addresses included in these files.

It should be noted that, in order to avoid enormous storage of chunks in memory MEM2, the chunks that have been broadcast are generally stored in the memory of the server over a given time range preceding the current broadcast time. Hatched lines in FIG. 1 illustrate, in connection with various broadcast channels CH1 to CH3, storage of chunks that have already been broadcast and are accessible in time-shifted mode; in our example, only unfinished television programs are recorded in memory for access with time-shifted playback; the memory depths (lengths of the hatched strips) therefore differ in FIG. 1 due to different start times on the various channels CH1-CH3.

According to an aspect of the present disclosure, a management entity ENT1 manages the storage of the chunks by storing the chunks in a memory space of the playback device STB after they have been respectively played back. In our example, the chunks are stored in a space of the cache memory; these chunks are decoded and ready to be played back. The disclosure is not limited to this example; the chunks could also be recorded following reception and before decoding.

Unlike the prior art, in which the chunks stored in cache memory are only at the latest chunks broadcast (real-time chunks corresponding to what is live), an aspect of the present disclosure also proposes to store chunks in a memory space C2 of the playback device STB after they have been played back by the playback device STB so as to access these chunks, if necessary, in time-shifted mode directly from the memory space in question.

In other words, a space C1 of the cache memory of the playback device STB is dedicated to audio/video chunks that are to be played back, like in the prior art; and a space C2 of the cache memory is dedicated to audio/video chunks that have been played back, the latter space C2 corresponding to a “retention buffer” for played-back chunks.

The depth of the memory space C2 (the retention buffer), and therefore of chunks that have already been played back, may be either of fixed size (for example 30 seconds, thereby making it possible to jump back 3 times in the past by 10 seconds) or of dynamic size, depending on the memory available on the equipment.

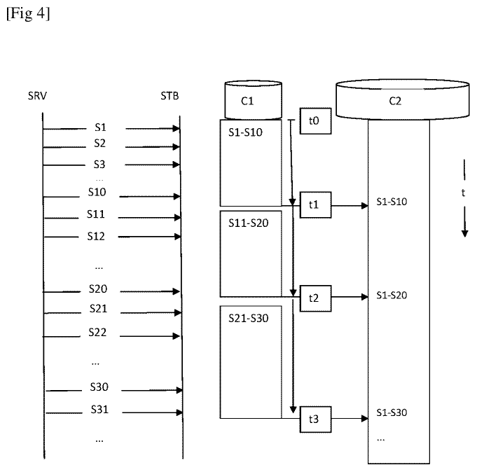

FIG. 4, described below, will make it possible to schematically illustrate one possible embodiment.

It will be assumed here that the server SRV makes available a list of content from respective television broadcasting channels.

This FIG. 4 comprises two axes associated with the server SRV and with the playback device STB.

FIG. 4 also shows the two memory spaces C1 and C2, introduced above, associated with the playback device STB; it will be recalled that one of the spaces C1 is dedicated to the storage of chunks associated with the real-time stream, and the other space C2 is dedicated to chunks that have been played back and stored in order to be accessible in time-shifted mode from this second memory. In our example, these two spaces are spaces of a cache memory.

It will also be assumed in our example that the chunks created and broadcast at the server SRV are stored, as explained above, in the memory MEM2 of the server. The chunks are therefore also accessible from this memory MEM2 in time-shifted mode.

Ultimately, an aspect of the present disclosure offers time-shifted playback of chunks, the playback resulting either from stored chunks stored locally in the retention space C2 associated with the playback device STB, or from chunks stored in the memory MEM2 of the server SRV described above.

A function called “start over” by those skilled in the art makes it possible to play back stored chunks from the memory MEM2 and to play back the content in time-shifted mode.

The entity ENT1 will therefore manage the mode of operation of the “start over” function by requesting the chunks either from the memory MEM2 or from the memory space C2.

A time axis “t” is also shown in this FIG. 4.

It will be assumed that, at a time t0, the playback device STB asks the server SRV for read access to a channel CH1. An access request (not shown in the figure because it is not relevant to the disclosure) is transmitted from the playback device STB to the server SRV.

Following receipt of the request, the server SRV successively transmits manifest files describing sets of chunk descriptions including URLs for accessing the chunks.

The playback device STB receives the files successively, reads these manifest files and downloads the chunks described by using the URLs included in the manifest files one after another.

In our example, the chunks S1 to S10 are received successively. The chunks are stored in the first cache memory, referenced C1. The chunks are then decoded and played back by the playback device STB one after another and rendered on the rendering device TV.

According to an aspect of the present disclosure, after reception from the network, the received chunks S1-S10 are stored in the space C1 of the playback device STB. In addition, the entity ENT1, after reading the files, stores the played-back chunks in the memory space C2 so that they are able to be replayed later in time-shifted mode. In other words, the playback device STB comprises a memory space C2 storing the chunks played back by the playback device STB.

FIG. 4 shows multiple phases of processing groups of chunks (S1-S10, S11-S20, S21-S30):
the chunks S1 to S10, after reception from the network, are stored in the first memory space C1 from the time t0 to t1, and erased from this first memory space C1 after these chunks have been played back by the playback device STB. At the time t1 described above, after the chunk S10 has been played back, the chunks S1 to S10 having been played back, said chunks are transferred to the second cache memory space C2.
As the content continues to be played back, the chunks S11 to S20 are then successively stored in the first memory space C1 from the time t1 to t2, and erased from this first memory space C1 after these chunks have been played back by the playback device STB. At the time t2, after the chunk S20 has been played back, the chunks S11 to S20 having been played back, said chunks are transferred to the memory space C2 and added to the chunks S1 to S10 already present in the memory space C2. At this stage, the memory space C2 contains the chunks S1 to S20.
As the content continues to be played back, the chunks S321 to S30 are then stored in the first memory space C1 from the time t2 to t3, and erased from this first memory space C1 after these chunks have been played back by the playback device STB. At the time t3, after the chunk S30 has been played back, the chunks S21 to S30 having been played back, said chunks are transferred to the memory space C2 and added to the chunks S1 to S20 already present in the memory space C2. At this stage, the memory space C2 contains the chunks S1 to S30.

It is obvious that, if the content comprises more chunks, the method described above continues for the chunks in question.

The chunks retained in the memory space C2 are not retained indefinitely, because of the limited memory size of this space C2 in terms of kilobytes. For this reason, the retention has a limited duration chosen according to requirements and/or the size and/or the power of the resources of the playback device STB. As indicated above, the depth of this retention memory (and therefore of chunks that have already been played back) may be either of fixed size (for example also 30 seconds, thereby making it possible to jump back 3 times in the past by 10 seconds) or of dynamic size, depending on the memory available on the equipment.

It will then be assumed that, during live playback, a request for time-shifted access is received by the playback device STB. This request is for example made from a remote control manipulated by a user. In this case, in our example, the entity ENT1 checks for the presence of the requested chunks in the second space C2; if they are present, the entity ENT1 asks to read the chunks from this second memory space C2 (the retention memory) in order to play back the chunks in time-shifted mode. At this stage, the time-shifted playback of the chunks is carried out on the basis of the chunks stored in the second memory space C2; the chunks are played back one after another.

The chunks are generally encoded, and are decoded in the playback device STB before being played back. It should be noted here that the chunks stored in the second memory space C2 are chunks that have been played back and have been decoded. It will therefore be understood that the playback from the second space C2 takes place without having to decode the chunks, the latter having already been decoded. The chunks are therefore played back quickly from this second space, because there is no need for decoding.

In addition, the second memory space C2 forms part of a cache memory. The chunks in the memory space C2 are ready to be played back. Playback from the second space C2 is therefore simpler than remote access; the processing operations are simplified, and the processor of the playback device STB is therefore called upon less.

The embodiment described above may be subject to variants, including the following.

According to one possible variant, the entity ENT1 asks to stop receiving manifest files while chunks are being played back from the second memory space C2. This means that the playback device STB no longer receives manifest files while chunks are being played back from the second space C2.

According to another variant, the entity ENT1 may also continue to receive manifest files in parallel; this may be useful for example if access to the second space C2 is defective and playback is no longer possible from this space; the parallel reception of manifest files makes it possible to request downloading of the chunks.

According to another variant, following the stop request, the entity ENT1 may ask to resume downloading of the manifest files.

The stopping and the resumption may be requested at an appropriate time, said time ideally being chosen so that the playback of the chunks is continuous and therefore uninterrupted.

Provision may be made to resume receiving the manifest files after all of the chunks stored in the second cache memory C2 have been played back. This resumption may also be provided at another time, for example before the latest chunks stored in the second cache memory C2 have been played back, in order to anticipate the switch from playing back the chunks from C2 to playing back the chunks downloaded from the server SRV.

It should be understood that time-shifted playback may be carried out over a relatively short period, for example thirty seconds as explained above. In order to be able to play back chunks located beyond thirty seconds in time-shifted mode, the management entity ENT1 is able to evaluate the need to play back chunks from the second space C2 or to read a manifest file describing older chunks located more than thirty seconds in the past. For this purpose, the entity ENT1 receives the request and, depending on the desired time-shifted playback,
the entity either asks to play back the chunks from the second space C2 if the chunks are recorded in this second space C2,
or asks to download the chunks from the memory MEM2 of the server when for example the requested chunks are older than those stored in the second memory space C2.

Lastly, it should also be pointed out here that the term “entity” or “module” may correspond equally to a software component or to a hardware component or to a set of software and hardware components, a software component itself corresponding to one or more computer programs or subroutines or, more generally, to any element of a program able to implement a function or a set of functions such as described for the modules in question. In the same way, a hardware component corresponds to any element of a hardware assembly that is able to implement a function or a set of functions for the module in question (integrated circuit, chip card, memory card, etc.).

1. A management method implemented by a management entity of a playback device and comprising:
managing storage of chunks of multimedia content, the managing comprising:
receiving the multimedia content, which is broadcast from a broadcast server via a communication network;
storing the chunks of the multimedia content in a memory of the playback device before the chunks are played back, wherein the chunks are retained in the memory after playback.

2. The management method as claimed in claim 1, comprising retaining the chunks in the memory over a given duration.

3. The management method as claimed in claim 1, wherein the chunks that are broadcast are stored in a memory associated with the server, and the method comprises time-shifted playback comprising playing back retained chunks or playback from the memory associated with the server.

4. The management method as claimed in claim 3, wherein an origin of the chunks to be played back in time-shifted mode depends on a desired time-shifted playback time.

5. The management method as claimed in claim 3, wherein accessing chunks requires receiving successive manifest files, and wherein the manifest files stop being received while the chunks retained in memory are being played back.

6. The management method as claimed in claim 5, wherein the method comprises resuming reception of the manifest files after the retained chunks have been played back.

7. A playback device comprising:
at least one processor; and
at least one non-transitory computer readable medium comprising instructions stored thereon which when executed by the at least one processor configure the playback device to manage storage of chunks of multimedia content by:
receiving the multimedia content, which is broadcast from a broadcast server via a communication network; and
storing the chunks in a memory of the playback device before the chunks are played back, wherein the playback device retains the chunks in the memory after playback.

8. A non-transitory computer readable medium comprising code instructions stored thereon, which, when executed by a processor, carry out a management method comprising:
managing storage of chunks of multimedia content by:
receiving the multimedia content, which is broadcast from a broadcast server via a communication network;
storing the chunks of the multimedia content in a memory of the playback device before the chunks are played back, wherein the chunks are retained in the memory after playback.
